(19) United States
(12) Patent Application Publication
(10) Pub. No.: US 2001/0004270 A1
(43) Pub. Date: Jun. 21, 2001

(54) Autofocus device and autofocus method

(75) Inventors: Kazuyoshi Nakamura, Tokyo (JP); Kenichi Matsumura, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/741,423

(22) Filed: Dec. 21, 2000

(30) Foreign Application Priority Data
Dec. 21, 1999 (JP) 11-363490

(51) Int. Cl. H04N 5/232; G03B 13/00

(52) U.S. Cl. 348/345

(57) ABSTRACT

An imaging device has both ends fixed to a metallic belt installed on two pulleys. A controller reversely turns a stepping motor to restore the imaging device to a position of origin and then a height sensor calculates the number of pulses according to imaging distance sensed. The controller rotates the motor in a forward direction to linearly transport the imaging device in a direction beginning at the origin position to stop the imaging device at a focused point. An autofocus operation can be achieved under feedforward control. This leads to a high-speed control operation, and the positioning can be conducted with high precision. The autofocus operation can be achieved at a high speed with high precision.

### BACKGROUND OF THE INVENTION

The present invention relates to an autofocus device and an autofocus method for automatically adjusting a focal point of a lens of an imaging apparatus or the like.

1. Prior Art

Description will be given of an autofocus device of the prior art by referring to FIGS. 1 to 4.

FIG. 1 shows a configuration of a fine focusing device in a schematic diagram for explaining a fine focusing method employed in, for example, a digital copier.

In the structure of FIG. 1, an imaging device 141 includes a substrate 142 on which an imaging element 143 such as a charge-coupled device (CCD) or the like is mouned. The substrate 142 includes an end section rotatably supported by a fulcrum 140 as a rotary axis. Light of a target object passes through a lens 144 and the light is produced by an imaging device 143. The lens has an infinite point 145 and a nearest point 146.

In the above-mentioned system, the substrate 412 has weight less than that of the imaging device 141. Therefore, the focusing can be achieved by turning the substrate 142 about the fulcrum 140 on the end section of the substrate 142.

FIG. 2 shows a configuration described in the Japanese Patent Application Laid-Open No. HEI 9-311903. In the configuration, an imaging device 51 includes a driving coil 52, a driving magnet 53, and a capacitive position sensor 54. The sensor 54 detects a position of the imaging device 51. A current produced by the sensor 54 according to a sense value is then fed to the driving coil 52 to slightly move the imaging device 51 by fine distance of displacement by electromagnetic force. In FIG. 2, the imaging device 51 has an imaging direction 56.

FIG. 3 shows structure described in the Japanese Patent Application Laid-Open No. HEI 4-62511 including a camera section 65 and an imaging device 64 disposed therein. In the constitution, a base member 68 includes a yoke/coil section 67, a movable lens 62 attached to the base member 68, a front lens 62, and a rear lens 63. The yoke/coil section 67 displaces the movable lens 62 in a lens displacement range 66 between the front lens 61 and the rear lens 63 by electromagnetic force. As a result, an electric, automatic focus lens is implemented without moving the imaging device 64 in the camera section 65.

FIG. 4 shows a configuration of an autofocus mechanism for a single-lens reflex camera or the like described in the Japanese Patent Application Laid-Open No. HEI 2-167513.

The configuration of FIG. 4 is basically similar to that of FIG. 3. However, in the autofocus mechanism of FIG. 4, a movable lens 72 is transported between a front lens 71 and a rear lens 73 by an ultrasonic motor 74. Specifically, an image signal produced by an imaging device 75 is used to search for a focused point. According to the image signal, the ultrasonic motor 74 drives the movable lens 72 to travel between the front lens 71 and the rear lens 73.

However, the method shown in FIG. 1 is attended with problems: \mathring{1}the focusing range is quite narrow and \mathring{2}the method cannot be applied to a line or linear sensor such as a one-dimensional CCD. In the method of FIG. 2, \mathring{3}due to adoption of feedback control, a position determining sensor (an encoder) such as a capacitive position sensor 54 is required.

Moreover, \mathring{4}since the displacement is relatively small, it is difficult to provide displacement distance necessary for a short-distance imaging operation.

In addition, \mathring{5}since the substrate of the imaging device 51 is lightly held only by a live axle, a long period of time is required to set the substrate in a stationary state because of influences of vibration and swing after the displacement thereof.

In the method shown in FIG. 3, \mathring{6}since a heavy body of the movable lens 62 is displaced over the range of motive freely, a long autofocus time is required because of insufficient response. Furthermore, \mathring{7}since the coil is disposed to enclose the heavy weight lens to drive the lens, the imaging device including the base member with magnet 68 becomes large in size.

The method of FIG. 4 is attended with a problem that \mathring{8}the image signal must be fed back and hence the imaging device cannot be utilized to shoot, for example, each object which is being transported by a conveyor. Additionally, \mathring{9}the lens transporting structure has a short life of several million transporting operations.

### SUMMARY OF THE INVENTION

It is therefore an object of the present invention, which has been devised to remove the problems \mathring{1}to \mathring{9}, to provide an autofocus device and an autofocus method in which a focusing operation is conducted at high speed and the autofocus device is also stable after the focusing operation.

In accordance with the present invention, there is provided an autofocus device, comprising transporting means for linearly transporting imaging means to generate an image of a target object and control means for controlling said transporting means to transport said imaging means.

There is provided an autofocus method in accordance with the present invention. The method comprises the step of linearly transporting imaging means to generate an image of a target object.

Another autofocus method in accordance with the present invention comprises the steps of sensing imaging distance between the imaging means and the target object, calculating distance of displacement of the imaging means according to the imaging distance sensed, and conducting control to linearly transport the imaging means by the distance of displacement calculated.

In the autofocus device and the autofocus method in accordance with the present invention, the imaging means is first transported to a position of origin and then is transported in a predetermined direction beginning at the position of origin.

In accordance with the present invention, the calculation may be conducted using a table containing a relationship between the imaging distance measured by the sensor means and the distance of displacement.

In accordance with the present invention, the imaging means may be linearly transported using a first pulley driven by a motor, a second pulley, and a belt onto which the imaging means is fixed and which is installed between said first and second pulleys.

In accordance with the present invention, the belt may be made of metal, the motor may be a stepping motor. The belt may be fixed onto the first pulley.

In accordance with the present invention, the imaging means may include an end section fixed onto said belt and one other end section rotatably attached onto a slider. There may be employed two groups of units each of which includes said first and second pulleys and said belt, and said imaging means includes both end sections respectively fixed onto said belts.

In accordance with the present invention, actual distance of displacement of said imaging means may be sensed under the control of the imaging means.

### BRIEF DESCRIPTION OF THE DRAWINGS

The objects and features of the present invention will become more apparent from the consideration of the following detailed description taken in conjunction with the accompanying drawings in which:

FIG. 1 is a diagram schematically showing a configuration of an autofocus device in the prior art;

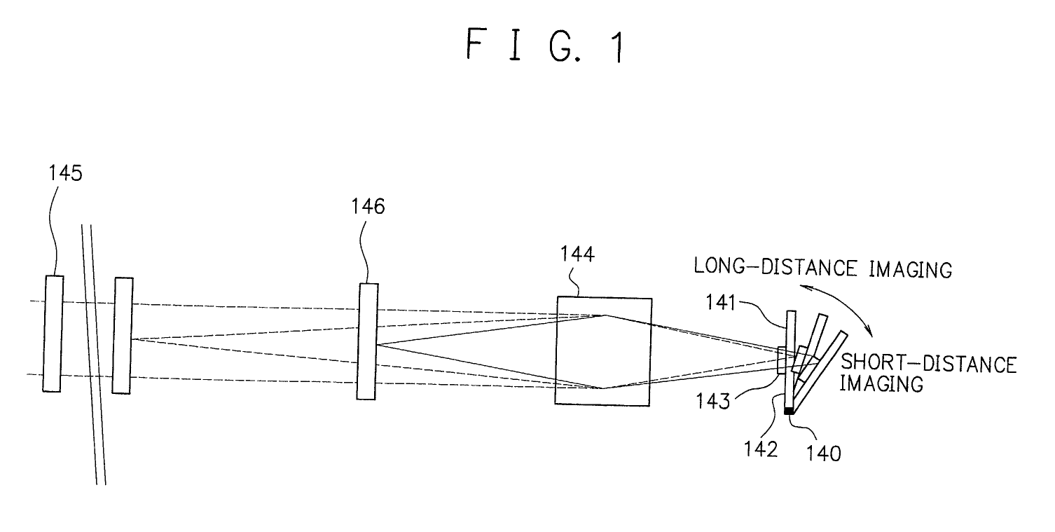

FIG. 2 is a schematic diagram showing structure of an autofocus device in the prior art;

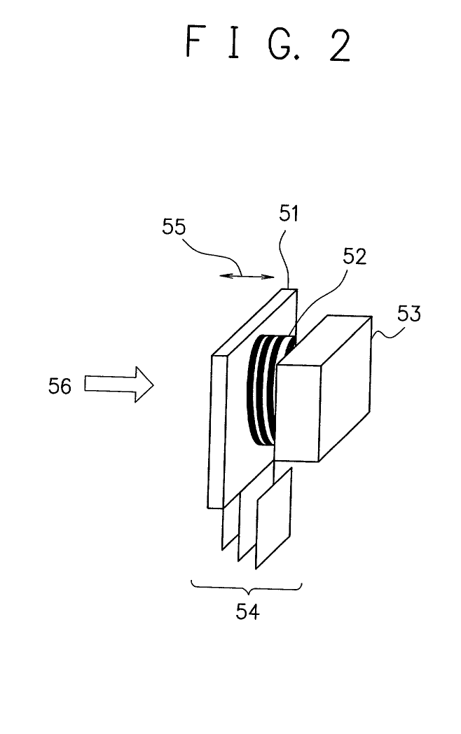

FIG. 3 is a diagram illustratively showing constitution of an autofocus device in the prior art;

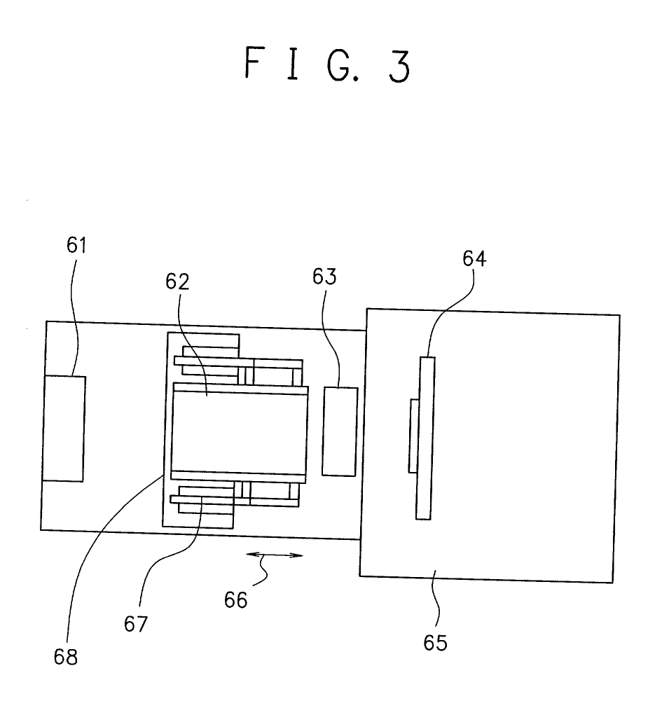

FIG. 4 is an illustrative diagram showing a construction of an autofocus device in the prior art.

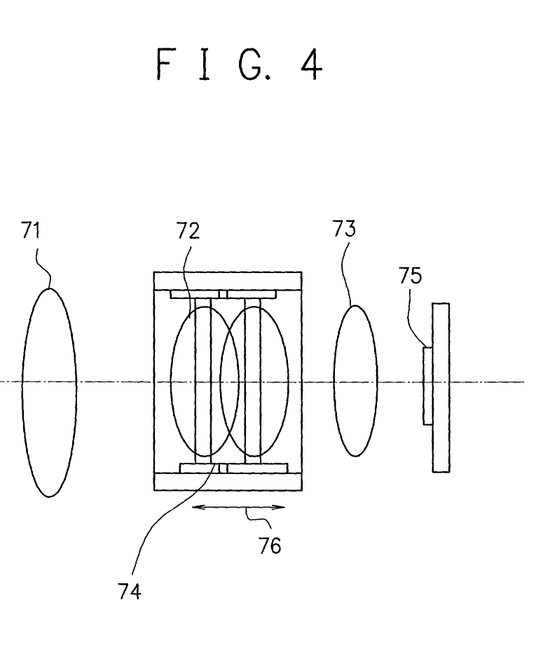

FIG. 5 is a schematic block diagram showing a configuration a first embodiment of an autofocus device in accordance with the present invention;

FIG. 6 is a schematic configuration block diagram for explaining actual operation of the first embodiment of an autofocus device in accordance with the present invention; and

FIG. 7 is a block diagram illustratively showing a configuration a first embodiment of an autofocus device in accordance with the present invention;

### DESCRIPTION OF THE PREFERRED EMBODIMENTS

Referring next to the accompanying drawings, description will be given of an embodiment of an autofocus device in accordance with the present invention.

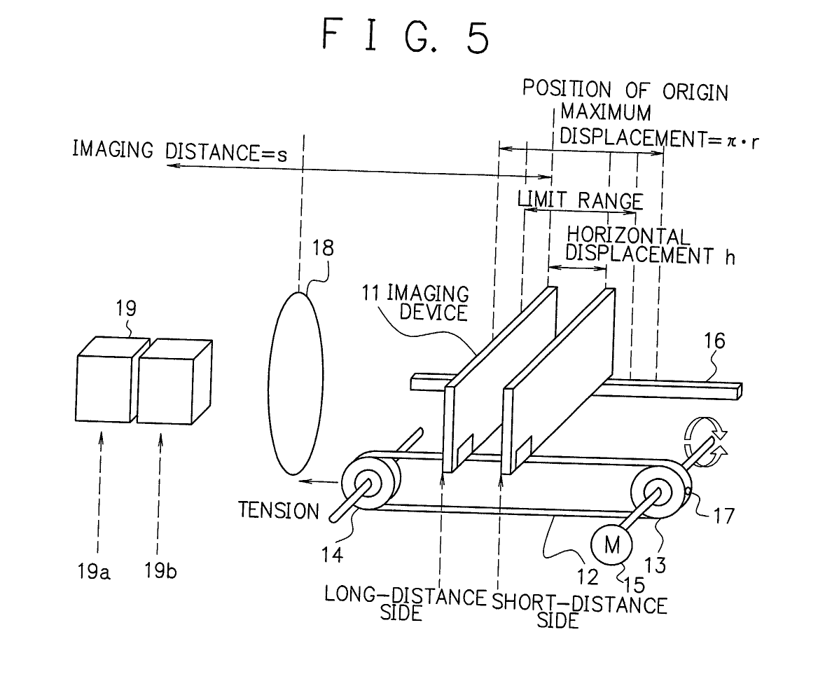

FIG. 5 shows a configuration of a first embodiment of an autofocus device in accordance with the present invention.

The system structure of the first embodiment shown in FIG. 5 includes pulleys 13 and 14, a metallic belt 12 installed between the pulleys 13 and 14, an imaging device 11 fixed by the metallic belt 12, and a stepping motor 15. The motor 15 directly drives the pulley 13 to linearly transport or displace the imaging device 11.

In the construction, the imaging device 11 can be adjusted to a desired position at a high speed while suppressing play of position adjustment of the imaging device 11. Resultantly, according to imaging distance between a target object 19 and the imaging device 11, the imaging device 11 can be moved to a position of an in-focus condition to achieve a stable autofocus operation at a high speed. For a stable position reproducibility, the encoder feedback is removed from the operation of the configuration.

The first embodiment will be more specifically described by referring to FIG. 5.

As well known in the field of optics, for a lens having a focal length of f, an in-focus condition is expressed as 1/f=1/a+1/b, where a is imaging length between a front principal point of the lens and a target object and b is distance between a rear principal point of the lens and a plane of a focal point (a surface of a film). Under the condition, a target image is magnified by a magnification factor of b/a.

The relationship indicates an appropriate condition for the focusing as follows. Using a lens with a standard focal length of about 35 millimeters (mm) to about 70 mm, to produce a focused image on a CCD (several millimeters to several centimeters (cm): measuring at diagonal line of CCD rectangular shape) in a relatively short distance ranging from 1.0 meter (minimum distance=about 0.5 meter) to several meters with a size of visual field ranging from about several tens of centimeters to about one meter, it is only necessary to move the position of focal plane b at most several tens of millimeters (about several millimeters in actual cases).

FIG. 5 shows a construction of an autofocus device to achieve the operation.

In the configuration of FIG. 5, the imaging device 11 includes an end section fixed onto an inflexible belt 12, which is a metallic belt in many cases. The belt 12 applies sufficient tension onto the pulley 13. The belt 12 is fixed by a fixing pin 17 onto the pulley 13. The pulley on a non-driving side 14 includes a mechanism to apply sufficient tension to the belt 12. The configuration further includes a lens 18 fixed at a predetermined position.

Assume that the pulley 13 has a radius of r and the pulley 14 has a radius of R.

When necessary, a slider 16 is arranged depending on the fixing position of the belt 12 onto the imaging device 11 to slidably support another end section of the imaging device 11. This guarantees a stable state of the imaging device 11. Namely, the configuration prevents various movements such as inclining, swinging, and distortion of the imaging device 11.

Thanks to the construction, the belt 12 can transport the imaging device 11 in a stable state by a maximum displacement distance of π·r.

Actually, in consideration of size and margin of the fixing pin 17, a horizontal displacement distance h is obtained as (0.5 to 0.8)×π·r. Specifically, 0.5 ×π·r is an imaging device position for a nearest imaging operation and 0.8 ×π·r is an imaging device position for a farthest imaging operation.

When the maximum displacement range is exceeded, the fixing pin 17, the pulleys 13 and 14, and/or the belt 12 may be destructed. To prevent the destruction, a limit is set to the displacement as below.

Maximum displacement range ⊃ Operation limit range ⊃ Horizontal displacement range

Horizontal displacement range=Displacement range between position of imaging device 11 on short-distance side and position of imaging device 11 on long-distance side

The driving pulley 13 is directly driven by the motor 15. The motor 15 may be, for example, a motor with an absolute value encoder, a stepping motor of which a position is determined after origin is once determined, or a servo motor with an integral rotary encoder.

In the displacement of the imaging device 11 to a position corresponding to the target object 19, it is desired in some cases to improve position reproducing precision by a one-directional travel or transportation in which the imaging device 11 is once restored to the origin before the imaging device 11 is displaced to the position. In this case, since the imaging device 11 is rarely shifted or deviated from an appropriate position because of pulse errors, a stepping motor is often employed to reduce the production cost.

When the imaging distance (=a) between the lens 18 and the target object 19 is known, an appropriate position of imaging device (=l) can calculated using the focal distance of lens (=f) and a flange-back distance (=L; an appropriate imaging device distance for a point at infinity). By rotating the motor 15 according to the result of the calculation, the imaging device 11 can be displaced to an appropriate position.

1/f=1/a+1/b b=(L+l)

Depending on aberration and focus adjusting or setting (not focused for a point at infinity) of the lens 18, there may be used a table containing a relationship between a and l, the table being generated through actual measurement of a and 1 for various states of focusing. The measurement is based on a point at infinity for the following reason. In a state in which the lens 18 is focused for a point at infinity by assuming that a long-distance side 19a of the target object 19 is a point at infinity, distance from the lens 18 to a plane on which an appropriate focus is established by the lens 18 is a flange-back distance L (the calculation is theoretically most simple if a point corresponding to the flange-back distance L is set as the origin).

However, the actual imaging distance is at most several meters, and the optimal focusing position of the lens also varies in this case. Therefore, the formulas above cannot be used in some cases, and the table generated through the actual measurement may lead to higher precision. Actually, eccentricity of the pulleys 13 and 14 and positional deviation or shift of a shaft of the motor 15 can be absorbed by the table and hence focusing efficiency is improved.

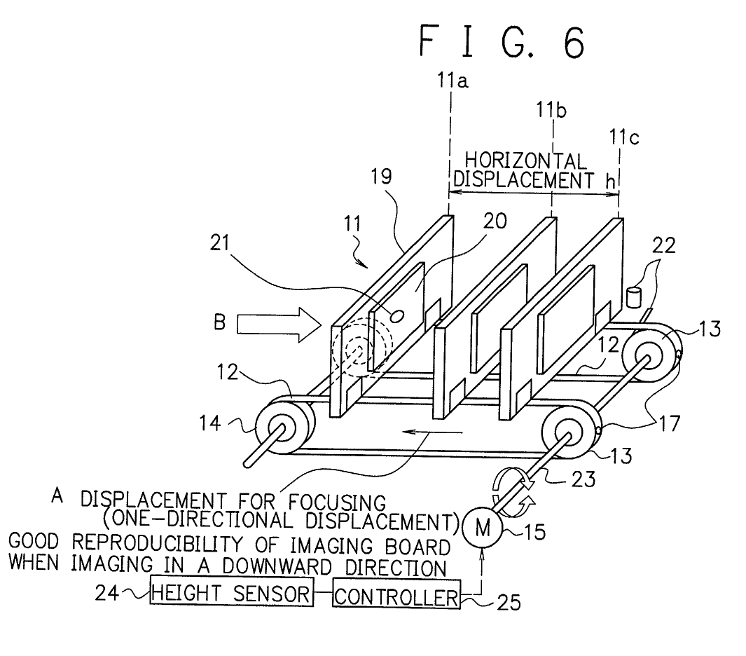

Referring now to FIG. 6, description will be given in detail of overall operation of the first embodiment.

FIG. 6 shows a configuration of an autofocus device in which a camera is installed over a conveyor to shoot an upper surface of a target object which is placed on the conveyor and which is transported by the conveyor. In FIG. 6, the conveyor is placed on the left side of the camera.

The configuration of FIG. 6 includes two groups of units of which each including two pulleys 13 and 14 and one belt 12. The system further includes an imaging device 11 including a substrate 19, an imaging element 20 such as a CCD, and a CCD radiator plate 21. The imaging device 11 has an imaging direction indicated by an arrow mark B.

When a target object is transported by the conveyor up to a predetermined point, a motor 15 such as a stepping motor is reversely driven to reversely turn the pulleys 13 and 14. When the imaging device 11 arrives at a predetermined position as a result, an origin sensor 22 such as a light shielding sensor starts operation to stop the rotation of the motor 15. Resultantly, the imaging device 11 is placed at a position of origin 11c. At the origin 11c, the imaging device 11 is farthest from the lens 18 of FIG. 5, namely, on a light-most side, actually, at an upper-most position.

The system then obtains, by a height sensor 24, height (imaging distance) of the target object on the conveyor. According to information of the height, a controller 25 searches a table to obtain displacement distance (number of displacement pulses) of the imaging device 11. The controller 25 drives the motor 15 for forward rotations according to the number of pulses. This transports the imaging device 11 in a direction indicated by an arrow mark A up to a position between a position 11b and a position 11a.

In this operation, the imaging device 11 is displaced in one direction (actually in a downward direction) as indicated by the arrow mark A. By additionally using the table generated through actual measurement, reproducibility of the position of the imaging device 11 is guaranteed. Thanks to the one-directional displacement, the automatic focusing can be accomplished without using the feedback control.

To displace the imaging device 11 in a state in which the imaging device 11 is stable in the vertical direction, namely, the imaging device 11 does not swing during the displacement, two groups of units each of which includes two pulleys 13 and 14 and one belt 12 are employed. The pulleys 13 and 14 are driven by one common driving shaft 23 which is directly driven by the motor 15.

When a CCD is adopted as the imaging element 20 of the imaging device 11, the CCD radiator plate 21 is disposed to radiate heat depending on cases.

A first advantage of the first embodiment is that the autofocus function can be achieved without any feedback control. This is because the imaging device 11 has high efficiency of position reproducibility, and the imaging device 11 need only be displaced with respect to the position of origin in the feedforward mode according to the imaging distance.

A second advantage of the first embodiment is that the imaging device can be transported by suppressing the swing of the imaging device which adversely influences imaging operation of a two-dimensional CCD or the like. Therefore, the autofocus device can be easily applied to the automatic focusing of a two-dimensional camera. This is because the imaging device is linearly driven in a direct fashion.

A third advantage of the first embodiment is that the focusing can be carried out at a high speed for the following reasons. The motor 15 turns a small rotation angle and drives relatively a light object in the configuration.

A fourth advantage is that the positioning can be achieved with small margin or play. This is because the belt is driven with high tension by direct driving.

A fifth advantage is that the system has a mechanically long life. When a maintenance-free motor 15 is employed, the system can be continuously operated without maintenance for the following reasons. The driving mechanism is quite simple and only a few sensors are used.

A sixth advantage is that the imaging device can be displaced by a long distance with high precision. This is because of the efficient mechanism to displace the imaging device. That is, two pulleys are coupled with each other by a belt, and the imaging device is fixed onto the belt. The imaging device can be displaced by a longer distance with higher precision when compared with a prior art system using a driver coil.

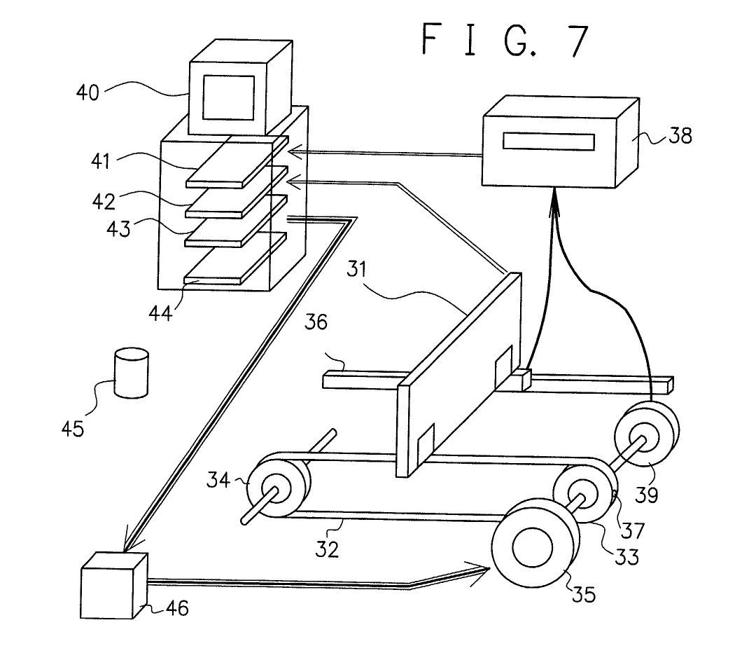

Referring now to FIG. 7, description will be given of a second embodiment in accordance with the present invention.

FIG. 7 shows constitution of an autofocus device as an experimental unit with an evaluating function. In the structure, an imaging device 31 includes an end section rotatably supported by a slider 36. The slider 36 also serves as a linear encoder. The linear encode/slider 36 sends an encoder value to an encoder processing unit 38.

The imaging device 31 includes another end section fixed onto a metallic belt 32. The belt 32 is installed between pulleys 33 and 34 and is fixed to the pulley 33 by a fixing pin 37. The pulley 33 is directly coupled with a stepping motor 35 and a rotary encoder 39. The rotary encoder 39 delivers an encoder value to the encoder processing unit 38.

The system also includes an overall processing unit 40. The unit 40 integrally includes a counter board 41 to acquire a count value from the encoder processing unit 38, an image receiving board 42 to obtain an image from the imaging device 31, a motor control board 43 to control a motor driver 46 to drive the motor 35, and a height sensor interface (I/F) board 44 to attain data from a height sensor (distance sensor) 45.

In the constitution, when the imaging device 31 is operated in under feedforward control according to the imaging distance, an actual rotation angle of the motor 35 is fed from the rotary encoder 39 to the encoder processing unit 38. Similarly, an actual position of the imaging device 31 is delivered from the linear encoder of the slider 36 to the encoder processing unit 38. The unit 38 sends the received information items to the overall processing unit 40. Resultantly, precision of the positioning operation in the feedforward mode can be confirmed.

According to experiments, to obtain a precision of about ten micrometers, the one-directional transportation is essential in the vertical driving. Due to influence from the eccentricity and the like, the motor rotation angle obtained by the calculation cannot appropriately lead to a focused state. To overcome the difficulty, the third embodiment adopts “the one-directional transportation after restoration to origin” and “table of relationship between imaging distance and rotation angle (number of pulses)” as in the second embodiment.

As a result, within 10 milliseconds from when the height sensor 45 senses height of the target object, the imaging device 31 can be transported in a stable state with a precision of about ten micrometers.

In accordance with the present invention, since the imaging apparatus such as an imaging device is transported in a linear fashion, the autofocus function can be achieved under feedforward control. Therefore, the imaging apparatus is stable after the displacement, that is, the troublesome vibration and swing are prevented. A stable autofocus operation can be consequently accomplished at a high speed with relatively a long displacement and high positioning precision.

By the one-directional displacement of the imaging apparatus relative to a position of origin in one direction, the autofocus operation can be conducted with higher precision.

When the imaging apparatus is fixed onto a belt and the belt is directly and linearly driven by pulleys or the like, the disadvantageous swing which adversary influences the imaging operation of a two-dimensional CCD or the like can be prevented. In consequence, long-distance displacement of the imaging apparatus can be carried out with high precision. The imaging apparatus is easily applicable to the autofocus operation of a two-dimensional camera.

In the configuration in accordance with the present invention, a relatively light-weighted imaging device is transported with a small rotation angle of the motor without moving heavy-weighted constituent elements such as a lens. This leads to a high-speed focusing operation.

Thanks to the direct driving by at least one metallic high-tension belt, the positioning can be achieved with little play.

Since the configuration includes a simple driving mechanism and only few sensors, the system has a long life. When a maintenance-free motor is adopted, the system can be operated with high durability without particular maintenance.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An autofocus device, comprising:
transporting means for linearly transporting imaging means to generate an image of a target object; and
control means for controlling said transporting means to transport said imaging means.

2. An autofocus device, comprising:
transporting means for linearly transporting imaging means to generate an image of a target object;
control means for controlling said transporting means to transport said imaging means; and
calculating means for calculating distance of displacement of said imaging means according to the imaging distance sensed by said sensor means,
said control means for controlling said transporting means to transport said imaging means by the distance of displacement calculated by said calculating means.

3. The autofocus device in accordance with claim 1, wherein said control means controls said transporting means to transport said imaging means to a position of origin and then to transport said imaging means in a predetermined direction beginning at the position of origin.

4. The autofocus device in accordance with claim 2, wherein said control means controls said transporting means to transport said imaging means to a position of origin and then to transport said imaging means in a predetermined direction beginning at the position of origin.

5. The autofocus device in accordance with claim 2, wherein said calculating means uses a table containing a relationship between the imaging distance measured by the sensor means and the distance of displacement.

6. An autofocus device in accordance with claim 1, further including:
sensor means for sensing imaging distance between said imaging means and said target object;
a first pulley driven by a motor;
a second pulley; and
a belt onto which said imaging means is fixed and which is installed between said first and second pulleys.

7. The autofocus device in accordance with claim 6, wherein said belt is made of metal.

8. The autofocus device in accordance with claim 6, wherein said motor is a stepping motor.

9. The autofocus device in accordance with claim 6, wherein said belt is fixed onto said first pulley.

10. The autofocus device in accordance with claim 6, wherein said imaging means includes an end section fixed onto said belt and one other end section rotatably attached onto a slider.

11. The autofocus device in accordance with claim 6, including two groups of units each of which includes said first and second pulleys and said belt,
said imaging section including both end sections respectively fixed onto said belts.

12. An autofocus device in accordance with claim 1, further including distance sensor means for sensing distance of displacement of said imaging means transported by said transporting means.

13. An autofocus method, comprising the step of linearly transporting imaging means to generate an image of a target object.

14. An autofocus method, comprising the steps of:
sensing imaging distance between the imaging means and the target object;
calculating distance of displacement of the imaging means according to the imaging distance sensed; and
conducting control to linearly transport the imaging means by the distance of displacement calculated.

15. The autofocus method in accordance with claim 13, further including the step of transporting the imaging means to a position of origin and then transporting said imaging means in a predetermined direction beginning at the position of origin.

16. The autofocus method in accordance with claim 14, wherein said control step includes the step of transporting the imaging means to a position of origin and then transporting the imaging means in a predetermined direction beginning at the position of origin.

17. The autofocus method in accordance with claim 14, wherein said calculating step includes the step of using a table containing a relationship between the imaging distance measured and the distance of displacement.

18. An autofocus method, comprising the step of linearly transporting imaging means to generate an image of a target object;
preparing a first pulley driven by a motor, a second pulley, and a belt onto which the imaging means is fixed and which is installed between the first and second pulleys; and
transporting the imaging means by the first and second pulleys and the belt.

19. The autofocus method in accordance with claim 18, wherein the belt is made of metal.

20. The autofocus method in accordance with claim 18, wherein the motor is a stepping motor.

21. The autofocus method in accordance with claim 18, wherein the belt is fixed onto the first pulley.

22. The autofocus method in accordance with claim 18, wherein the imaging means includes an end section fixed onto the belt and one other end section rotatably attached onto a slider.

23. The autofocus method in accordance with claim 18, including the steps of:
preparing two groups of units each of which includes the first and second pulleys and the belt; and
fixing the belts respectively onto both end sections of the imaging means.

24. The autofocus method in accordance with claim 13, further including the step of sensing distance of displacement of the imaging means transported by the transporting means.

25. The autofocus method in accordance with claim 14, further including the step of sensing distance of displacement of the imaging means transported by the transporting means.
